(19) United States
(12) Patent Application Publication
(10) Pub. No.: US 2004/0076704 A1
(43) Pub. Date: Apr. 22, 2004

(54) Progressing cavity extruder

(76) Inventor: Christopher S. Hannaford, Golden Valley, MN (US)

Correspondence Address: Wayne A. Sivertson, NAWROCKI, ROONEY & SIVERTSON, P.A., Suite 401, Broadway Street Northeast, 3433 Broadway Street Northeast, Minneapolis, MN, 55413, US

(21) Appl. No.: 10/682,461

(22) Filed: Oct. 9, 2003

Related U.S. Application Data
(60) Provisional application No. 60/417,621, filed on Oct. 9, 2002.

(51) Int. Cl. B29C 47/10

(52) U.S. Cl. 425/208; 425/209; 425/287; 425/376.1

(57) ABSTRACT

An extruder or dispenser assembly for dough-like material. A progressing cavity pump receives the material and delivers it to an extruder assembly or die. In a preferred embodiment, the output of the pump is separated into independent streams. Each stream may have a desired minor constituent (such as color and/or flavor) added with the streams being co-extruded, as desired. Static mixers may be employed to incorporate the minor constituents into each stream.

### BACKGROUND OF THE INVENTION

The present invention relates to extrusion or dispensing of dough-like materials and, more particularly, to extrusion or dispensing of viscous food doughs.

Doughs and dough-like materials are found in many arts. In the food industry, for example, doughs are used for bread and many candy products. Such doughs are typically sticky and are not truly a fluid in that they do not take the shape of a container in to which they are put. That is, a ball of dough mostly retains the shape of a ball.

In the food industry, and most particularly in the candy industry, it is often desired to produce shaped ropes, as by extruding. Because of the high viscosity (4,000,000-8,000,000 centipoises are common for licorice, for example) extrusion of such material may require the delivery of the dough at up to several hundred pounds per square inch (psi) of pressure. For many applications, it is also desirable, or necessary, to provide a mechanism which removes air bubbles from the dough.

One prior art system employs a single-screw, open-flighted extruder having an open hopper. The dough (licorice is common) is cooked continuously and dropped at atmospheric pressure into the hopper. Such extruders are limited to approximately 100 psi which limits their capabilities.

Another prior art system which is capable of generating more than 100 psi to improve extruding capabilities employs a twin-screw extruder and cooks the dough inside the extruder. By manufacturing the dough within the extruder, the problem of feeding the viscous, sticky dough is moot.

As noted above, the first mentioned prior art approach produces a pressure too low for many applications. The second described system provides sufficient pressure but is too costly for many applications. Also, in spite of the high cost, cooking the dough inside the extruder often produces an inferior dough.

In addition to delivering a food dough to a die efficiently and at sufficient pressure, it is often desired to intermix minor constituents such as colorants and/or flavorings. Static mixers are well known for this purpose and are used in a twin-screw extruder system disclosed in Christensen et al. U.S. Pat. No. 5,776,534 issued Jul. 7, 1998. The twin-screw, with its issues as described above, has output characteristics which allow utilization of prior art static mixers. See also Meisner U.S. Pat. No. 4,925,380 issued May 15, 1990 for the use of static mixers in a system wherein a product flow is split for separate coloring via static mixers.

### BRIEF DESCRIPTION OF THE PRESENT INVENTION

The present invention employs a progressing cavity pump which is capable of efficiently delivering high viscosity doughs and dough-like materials at the pressures necessary for effective extrusion with little shear damage. Progressing cavity pumps are known, having been patented in 1932 by Rene Joseph Moineau as shown and described in U.S. Pat. No. 1,892,217.

As is well known, progressing cavity pumps work well for products that can flow into their inlet hopper—those that are fluid (as opposed to dough-like) as represented generally by their viscosity. Such pumps are commonly used in the sewage industry for pumping slurries.

Food doughs, including candy dough, do not flow well, if at all. Also, it is important to not bring air bubbles with the product into the pump. For one, or both, of these reasons, or other reasons, progressing cavity pumps have not been employed for food doughs. That is, the inability of the dough to “flow” into the pump, and/or the air induced or carried with the dough into the pump by force feeding, have restricted the use of progressing cavity pumps in the food dough industry.

The present invention combines a roll feeder of known design with a progressing-cavity pump to provide a device which is suitable for extruding food doughs and, particularly, candy dough. Use of a screw feeder intermediate the feeder and progressing cavity pump is desirable.

The roll feeder consists of two counter-rotating rollers with a gap between them and two scrapers that remove product from the rollers on the discharge side. The roll feeder forces dough into the progressing cavity pump inlet or into the screw that feeds the progressing cavity pumps, if used. In addition, the roll feeder removes air from the dough and is capable of mixing any minor liquid ingredients such as flavorings and/or colorings which may be dripped onto the rolls or the dough in the hopper, for example.

In a preferred embodiment, the present invention provides an extruder for food dough. In its basic form, the outlet of the progressing cavity pump may be shaped. As such, the pump is an extruder for food dough. Alternatively, the pump output may be separated into separate streams with minor constituents being differentially added to each stream—to provide streams of different colors and/or flavors, for example. Those streams may then be co-extruded, if desired

The capability of the pump overcomes pressure drop in the piping and allows efficient mixing of the minor constituents, as by static or other mixers, without the need for expensive twin screw arrangements. Also the ability to add minor constituents downstream from the pump allows a fast changeover from one constituent to another, as will be obvious to those familiar with the art. Additionally, the fact that a progressing cavity pump is a positive displacement device allows cleaning of the system by circulation of water or other cleaning liquid.

### BRIEF DESCRIPTION OF THE DRAWINGS

FIG. 1 is a schematic representation of an extruder assembly in accordance with the present invention.

FIG. 2 is a schematic representation illustrating the operation of a roll feeder in accordance with the present invention.

FIG. 3 illustrates an alternative embodiment of a portion of the roll feeder illustrated in FIG. 2.

FIG. 4 illustrates a multi-stream co-extrusion arrangement in accordance with the present invention.

### DETAILED DESCRIPTION OF THE DRAWINGS

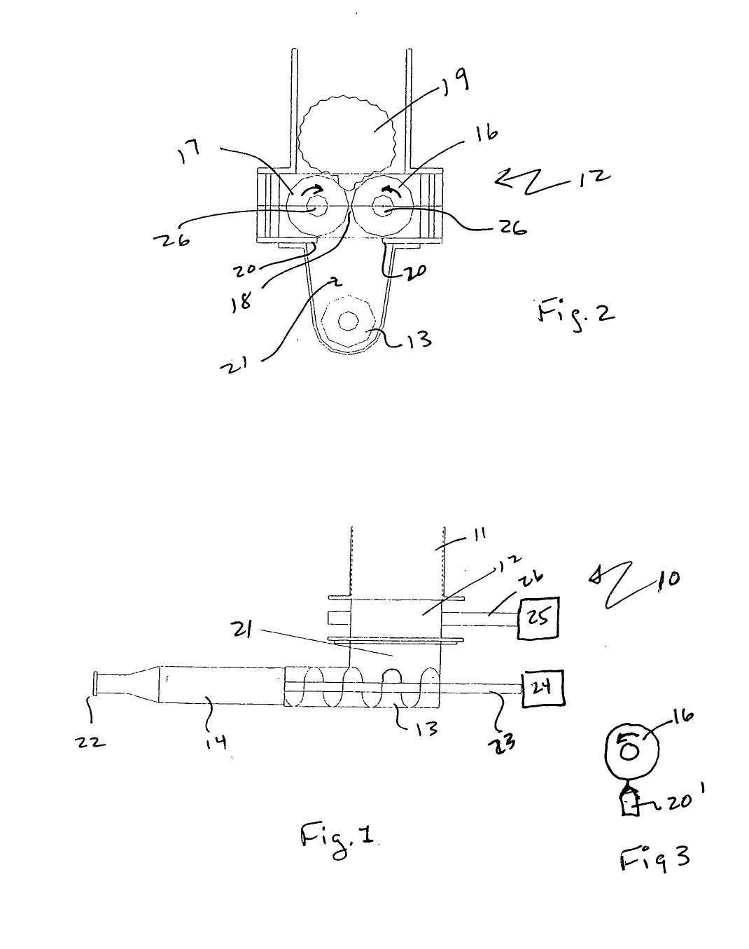

FIG. 1 illustrates an extruder assembly in accordance with the present invention including a hopper 11, a roll feeder 12, a screw feeder 13, progressing cavity pump 14 and extruding outlet 22. Progressing cavity pumps are known and are commercially available. In such pumps, a spiral, metal “rotor” rotates inside a tube which has a doubled-spiral stator cavity. A motor rotates the rotor which wobbles as it rotates in the stator, in known manner, to provide a positive displacement pumping action. For this application as an extruder, the progressing cavity pump should have a solid metal rotor and stator for higher pressure operation. Otherwise, the pump may be as described in U.S. Pat. No. 1,892,217 which is hereby incorporated by reference.

The screw feeder 13 is also known in the art in combination with progressing cavity pumps. Indeed, they may be bought in combination as a single unit such as that sold by Moyno Industrial Products under Model No. 1FGJ3SJG and other manufacturers. While it has been found desirable for a screw feeder 13 to be employed at the inlet 14 to deliver dough to the extruder, the screw feeder may not be required for all applications.

Dough to be extruded is delivered to the hopper 11 which serves to contain the dough and assists in maintaining it in position relative to the roll feeder 12. The cooperation of the hopper and roll feeder are illustrated in FIG. 2 wherein two (2) counter-rotating rollers 16 and 17 rotate in the direction of the arrows. The rollers 16 and 17 are located side by side having a gap or nip 18 of approximately ¼ inch between them. Rotation of the rollers forces the dough 19 through the nip 18 in a downward direction toward the screw 13. Scrapers 20 are provided to scrape most of the dough 19 from the rollers 16 and 17 leaving a layer of dough on the rolls approximately ⅛ inch thick. This dough coating on the rollers 16 and 17 facilitates the feeding of the roll feeder 12 while the scrapers 20 remove most of the dough. The action of the rollers 16 and 17 and scrappers 20 create a slightly pressurized area 21 at the inlet of the screw feeder 13. In the event that excess dough (dough that is not removed by the extruder assembly) is delivered to the chamber 21 by the roll feeder 12, it is forced backward through the nip 18 of the rolls 16 and 17 and into the ball of dough 19. The action of the rollers 16 and 17 at the nip 18 serves to de-air the dough as it passes through them rendering that dough particularly suitable for candy extrusion, for example.

As described, the present invention provides an extruder assembly for dough-like material employing a progressing cavity pump having an inlet and an outlet. A roll feeder is employed to deliver the dough-like material, under pressure, to the extruder assembly. The extruder assembly may include a screw feeder, as illustrated. In some instances the screw feeder may not be necessary. However, the feeder assembly is considered desirable for most applications. In any case, the use of a progressing cavity pump allows the extrusion of viscous dough-like material at high pressures. The outlet 22 of the assembly may be shaped to form the dough into a desired shape. That is, the outlet 22 may be a “die”. Alternately, outlet 22 represents other extruder configurations, as described below. As illustrated, shaft 23 drives both the screw 13 and pump 14, in known manner, the shaft 23 being powered by a motor 24. Similarly, a motor 25 drives shafts 26 of the rollers 16 and 17, the rollers 16 and 17 rotating with the shafts 26.

In the discussion above, outlet 22 is stated as representing an extruder. An extruder 22′ is illustrated in FIG. 4 including a manifold 30 which receives the output of the pump 14. Two output streams exit the manifold 30 via lines 31 and 32 to pass into mixers 33. The mixers 33 may be static mixers of type known in the art or other type of mixer, powered mixers, for exmample. Injectors 34 for minor constituents such as flavorings or colorants may deliver their output to the lines 31 and 32, the injectors 34 consisting generally of reservoirs for the desired constituents and pumps for delivering the desired amount of constituent to the lines 31 and 32, in known manner. It is within the skill of one familiar with the art to regulate the amount constituent based upon the flow in the lines 31 and 32.

After thoroughly mixing the minor constituents, the streams may be separately extruded, in known manner. However, an advantage of the present invention is the ability to provide separate, independent streams for the selective addition of minor constituents and then utilize those streams for co-extrusion. Thus, the streams flowing from the mixers 33 may be co-extruded as at a co-extrusion die 35. Given the capacity of an extruder in accordance with the present invention (resulting from the utilization of a progressing cavity pump), it is within the scope of the present invention to further divide the streams from the mixers 33 as by flow dividers 36, with one stream from each of the flow dividers 36 passing to the co-extrusion die 35 to result in a co-extruded product as represented at 37. The flow dividers may be those disclosed in Hannaford U.S. Pat. No. 5,536,517 issued Jul. 16, 1996. The flow dividers 36 illustrated in FIG. 4 have three outputs with the outputs 41, 42, 43, and 44 being directed to dies or co-extrusion dies, as desired. A pressure sensor 45 may be employed in a feedback pressure control loop so as to regulate the motor 24 of FIG. 1 to maintain the pressure of manifold 30 constant, in known manner. Pressure relief or control may also be provided, as by a valve, surge tank or recirculation back to the input, as is well known in the art.

As described, the output from the extruder in FIG. 1 may be employed for a single stream extrusion, a multiple stream extrusion or single or multiple stream co-extrusions, as desired. In any case, static mixers such as those illustrated at 33 in FIG. 4, may be employed to thoroughly intermix the desired minor constituents as provided by the injectors 34, in known manner. Thus, in accordance with the present invention, a dough-like material such as food dough may be advantageously extruded without the shear introduced in the prior art's high pressure systems and without their expense. Additionally, progressing cavity pumps are positive displacement pumps which provide other advantages.

Among the chief advantages of the positive displacement characteristics of the progressing cavity pump is the fact that its output is dependent upon the rotation of its drive shaft. That is, the drive rotation rate determines the rate at which product is extruded. Additionally, the positive displacement characteristics facilitates cleaning of the system. This is illustrated in FIG. 4 by the dashed line 46 which represents a recirculation flow back to the input of the pump 14 and/or screw feeder 13 of FIG. 1. While recirculation is not required, an excessive amount of cleaning fluid (such as water) would be otherwise circulated through the system for cleaning purposes. Indeed, a progressing cavity pump mostly self cleans when the supply of new product is stopped and the pump continues running for a short period. Not only does this facilitate cleaning it also facilitates a production changeover such as a change in the input material and/or its constituent. Of course, when minor constituents are injected or otherwise inserted downstream of the pump outlet, as described above with reference to FIG. 4, cleaning activities and/or product changeover are further facilitated.

In addition to ease of cleaning and control, the extrusion pressures produced by a progressing cavity pump allow a smaller diameter extruded ropes. Significantly, the pressure provided by such pumps is also sufficient to overcome the pressure drop of known static mixers when intermixing minor constituents. There is also a size advantage over prior art systems having similar capabilities.

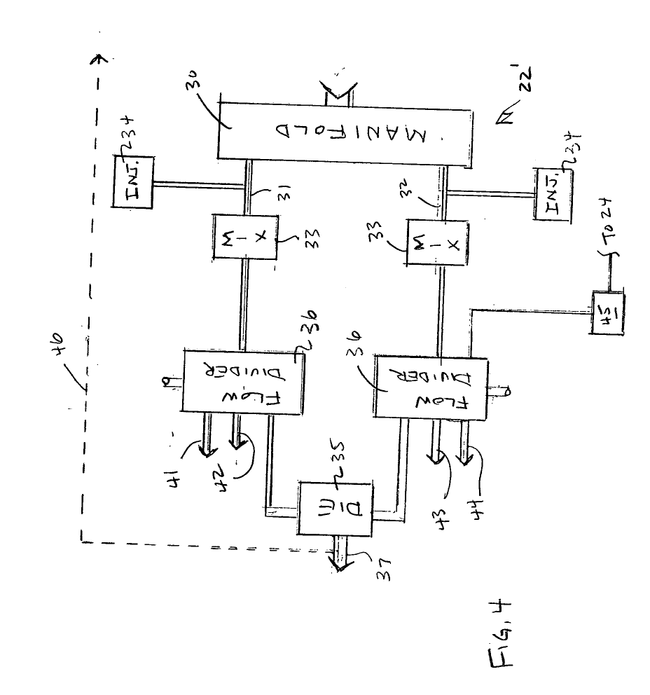

Obviously, many modifications and variations of the present invention are possible in light of the above teachings. For example, scrapers 20 illustrated in FIG. 2 are plate-like structures projecting into the area beneath the rollers 16. Alternatively, blade-like members 20′ (see FIG. 3) may be employed as scrapers for both rollers 16 and 17 (only rollers 16 being illustrated in FIG. 3). The various extrusion/co-extrusion alternatives are set out above. Blades or other devices may be used in conjunction with any of these alternatives to utilize the extruder as, or in, a depositer (an apparatus in which a viscous product is portioned, shaped and dispensed). It is therefore to be understood that, within the scope of the appended claims, the invention may be practiced otherwise than as specifically described.

In the claims.

1. An extruder assembly for dough-like material comprising:
progressing cavity pump means having an inlet and an outlet, the outlet being adapted to form the dough-like material into a desired configuration;
roll feeder means having first and second side-by-side, counter-rotating rollers and a discharge, the roll feeder means discharge being adapted to deliver dough-like material, under pressure, to the pump means inlet.

2. The extruder assembly of claim 1 wherein the inlet of said pump means comprises screw feeder means.

3. The extruder assembly of claim 1 wherein the progressing cavity pump means further comprises screw feeder means.

4. The extruder assembly of claim 1 wherein the pump means outlet comprises extruder means, said extruder means including means for incorporating minor constituents into said dough-like material.

5. The extruder assembly of claim 4 wherein said minor constituent incorporating means comprises static mixer means.

6. The extruder assembly of claim 4 wherein said extruder means comprises means for separating said dough-like material into at least two separate streams, said minor constituent incorporating means comprising means for independently and selectively incorporating minor constituents into said separate streams.

7. The extruder assembly of claim 6 wherein said extruder means comprises co-extrusion means, at least said first and second streams being co-extruded via said co-extrusion means.

8. The extruder assembly of claim 1 wherein the improvement further comprises screw feeder means interconnecting the roll feeder and progressing cavity pump.

9. An extruder for a dough comprising:
a progressing cavity pump having an inlet and an outlet;
a screw feeder adapted to deliver dough-like material to the progressing cavity pump; and,
extruder means operatively connected at the outlet of the progressing cavity pump.

10. The extruder of claim 9 wherein said extruder means includes means for incorporating minor constituents into said food dough.

11. The extruder of claim 10 wherein said minor constituent incorporating means comprises static mixer means.

12. The extruder of claim 10 further comprising means for separating said food dough into at least two separate streams, said minor constituent incorporating means comprising means for independently and separately incorporating minor constituents into said separate streams.

13. The extruder of claim 12 wherein said minor constituent incorporating means comprises static mixer means.

14. The extruder assembly of claim 12 wherein said extruder means comprises co-extrusion means, at least said first and second streams being co-extruded via said co-extrusion means.

15. The extruder of claim 14 wherein said minor constituent incorporating means comprises static mixer means.
